(19) United States
(12) Patent Application Publication
(10) Pub. No.: US 2026/0064364 A1
(43) Pub. Date: Mar. 5, 2026

(54) PROGRAMMING OF PARAMETERS FOR NONLINEAR FUNCTION IN NEURAL PROCESSOR

(71) Applicant: APPLE INC., Cupertino, CA (US)

(72) Inventors: Sayyed Karen KHATAMIFARD, Cupertino, CA (US); Jeffrey Dean MARKER, Pleasant View, UT (US); Thomas Gregory ANDERL, Seattle, WA (US)

(73) Assignee: APPLE INC., Cupertino, CA (US)

(21) Appl. No.: 18/825,905

(22) Filed: Sep. 5, 2024

(51) Int. Cl. G06F 7/491

(52) U.S. Cl. CPC G06F 7/4915; G06F 7/4912

(57) ABSTRACT

Embodiments of the present disclosure relate to storing parameters representing nonlinear functions in programmable memory circuits of a neural processor circuit and reusing the stored parameters across multiple tasks. The parameters are initially included in a task descriptor defining the configuration of the neural processor circuit for a task and are programmed into programmable memory circuits. Parameters for other nonlinear functions are stored in non-programmable memory circuits. In subsequent tasks, the stored parameters are reused to generate activation values for applying to processed output from multiply-accumulate (MAC) circuit by indicating, in task descriptors for the subsequent tasks, programmable or nonprogrammable memory circuits from which the parameters are to be retrieved. By replacing the parameters of the nonlinear functions with the indication of the memory circuits in the subsequent tasks, the amount of data to be included in the task descriptors of the subsequent tasks is reduced.

### BACKGROUND

### 1. Field of the Disclosure

The present disclosure relates to a neural processor for executing a neural network, and more specifically to storing parameters for deriving nonlinear activation functions in programmable memory circuits in the neural processor.

### 2. Description of the Related Arts

An artificial neural network (ANN) is a computing system or model that uses a collection of connected nodes to process input data. The ANN can be organized into layers where different layers perform different types of transformation on their input. Extensions or variants of ANN such as convolution neural networks (CNN), deep neural networks (DNN), recurrent neural networks (RNN) and deep belief networks (DBN) have come to receive much attention. These computing systems or models often involve extensive computing operations including multiplication and accumulation. For example, CNN is a class of machine learning technique that primarily uses convolution between input data and kernel data, which can be decomposed into multiplication and accumulation operations.

Depending on the types of input data and operations to be performed, these machine learning systems or models can be configured differently. Such varying configurations would include, for example, pre-processing operations, the number of channels in input data, the kernel data to be used, the nonlinear function to be applied to convolution result, and applying of various post-processing operations. Using a central processing unit (CPU) and its main memory to instantiate and execute machine learning systems or models of various configurations is relatively easy because such systems or models can be instantiated with mere updates to code. However, relying solely on the CPU for various operations of these machine learning systems or models would not only consume significant bandwidth of the CPU but also increase the overall power consumption.

### SUMMARY

Embodiments relate to a neural processor circuit including at least one programmable memory circuit for storing parameters that represent a nonlinear function corresponding to an activation function applied with results of multiply-accumulate operations. The parameters are included in a task descriptor defining the configuration of the neural processor circuit for a prior task. The parameters in the task descriptor for the prior task are stored in the at least one programmable memory circuit and retrieved for deriving the activation function in a current task subsequent to the prior task. A task descriptor for the current task may omit the parameters representing the nonlinear function but instead include an indication of one of the at least one programmable memory circuit that stores the parameters from which the activation function may be derived for the current task.

### BRIEF DESCRIPTION OF THE DRAWINGS

FIG. 1 is a high-level diagram of an electronic device, according to some embodiments.

FIG. 2 is a block diagram illustrating components in the electronic device, according to some embodiments.

FIG. 3 is a block diagram illustrating a neural processor circuit, according to some embodiments.

FIG. 4 is a block diagram of a neural engine in the neural processor circuit, according to some embodiments.

FIG. 5 is a block diagram illustrating a neural task manager in the neural processor circuit, according to some embodiments.

FIG. 6 is a diagram illustrating a task descriptor, according to some embodiments.

FIG. 7 is a block diagram illustrating a nonlinear (NL) function processor in the neural engine, according to some embodiments.

FIG. 8 is a graph illustrating a nonlinear function, according to some embodiments.

FIG. 9 is a flowchart illustrating a method of operating the neural processor circuit using the NL function processor, according to some embodiments.

The figures depict, and the detailed description describes, various non-limiting embodiments for purposes of illustration only.

### DETAILED DESCRIPTION

Reference will now be made in detail to embodiments, examples of which are illustrated in the accompanying drawings. In the following detailed description, numerous specific details are set forth in order to provide a thorough understanding of the various described embodiments. However, the described embodiments may be practiced without these specific details. In other instances, well-known methods, procedures, components, circuits, and networks have not been described in detail so as not to unnecessarily obscure aspects of the embodiments.

Embodiments of the present disclosure relate to storing parameters representing one or more nonlinear functions in one or more programmable memory circuits of a neural processor circuit and reusing the stored parameters across multiple tasks. The parameters are initially included in a task descriptor defining the configuration of the neural processor circuit for a task and are programmed into programmable memory circuits. Parameters for other nonlinear functions are stored in non-programmable memory circuits. In subsequent tasks, the stored parameters are reused to determine activation functions applied with processed outputs from a multiply-accumulate (MAC) circuit by indicating, in task descriptors for the subsequent tasks, the one or more programmable memory circuits or the non-programmable memory circuits from which the parameters are to be retrieved. By replacing the parameters of the nonlinear functions with the indication, the amount of data to be included in the task descriptors of the subsequent tasks may be reduced.

A “task” described herein refers to a processing operation of the neural processor circuit that instantiates a network layer of a neural network, multiple network layers of a neural network, or a portion of a network layer of a neural network. A task list described herein refers to a sequence of tasks, such as a sequence of tasks that are executed by the neural processor circuit to instantiate multiple network layers of a neural network. A task descriptor for a task indicates the hardware configuration and operational sequences of components of the neural processor circuit to perform the task.

### Exemplary Electronic Device

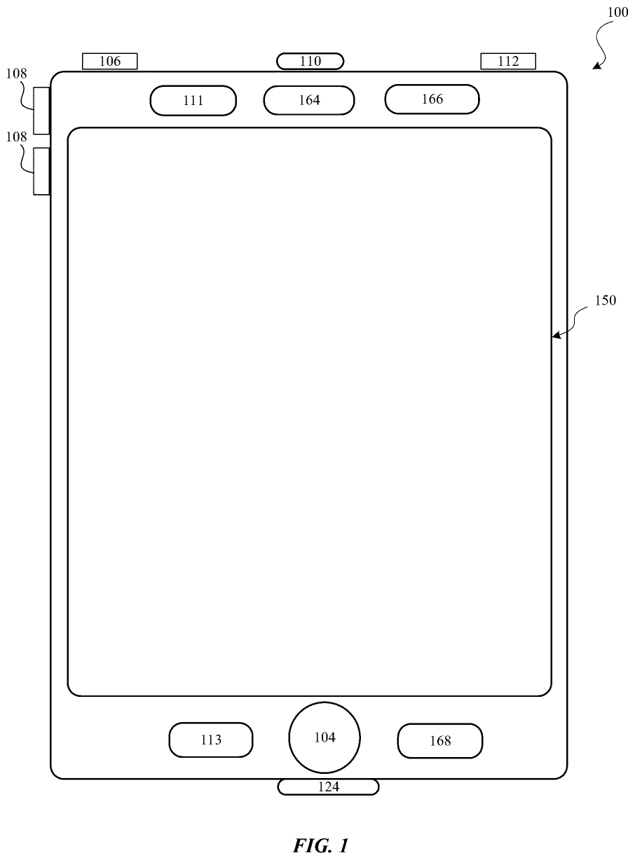

Embodiments of electronic devices, user interfaces for such devices, and associated processes for using such devices are described. In some embodiments, the device is a portable communication device, such as a mobile telephone, that also contains other functions, such as personal digital assistant (PDA) and/or music player functions. Embodiments of portable multifunction devices include, without limitation, the iPhone®, iPod Touch®, Apple Watch®, and iPad® devices from Apple Inc. of Cupertino, California. In some embodiments, the device is wearables such as a smartwatch or wireless earbuds. In some embodiments, the device is not a portable communications device, but is a desktop computer or other computing device that is not designed for portable use. In some embodiments, the disclosed electronic device may include a touch sensitive surface (e.g., a touch screen display and/or a touch pad). An example electronic device described below in conjunction with FIG. 1 (e.g., device 100) may include a touch-sensitive surface for receiving user input. The electronic device may also include one or more other physical user-interface devices, such as a physical keyboard, a mouse and/or a joystick.

FIG. 1 is a high-level diagram of an electronic device 100, according to some embodiments. Device 100 may include one or more physical buttons, such as a “home” or menu button 104. Menu button 104 is, for example, used to navigate to any application in a set of applications that are executed on device 100. In some embodiments, menu button 104 includes a fingerprint sensor that identifies a fingerprint on menu button 104. The fingerprint sensor may be used to determine whether a finger on menu button 104 has a fingerprint that matches a fingerprint stored for unlocking device 100. Alternatively, in some embodiments, menu button 104 is implemented as a soft key in a graphical user interface (GUI) displayed on a touch screen.

In some embodiments, device 100 includes touch screen 150, menu button 104, push button 106 for powering the device on/off and locking the device, volume adjustment buttons 108, Subscriber Identity Module (SIM) card slot 110, head set jack 112, and docking/charging external port 124. Push button 106 may be used to turn the power on/off on the device by depressing the button and holding the button in the depressed state for a predefined time interval; to lock the device by depressing the button and releasing the button before the predefined time interval has elapsed; and/or to unlock the device or to initiate an unlock process. In some embodiments, device 100 also accepts verbal input for activation or deactivation of some functions through microphone 113. Device 100 includes various components including, but not limited to, a memory (which may include one or more computer-readable storage mediums), a memory controller, one or more central processing units (CPUs), a peripherals interface, an RF circuitry, an audio circuitry, speaker 111, microphone 113, input/output (I/O) subsystem, and other input or control devices. Device 100 may include one or more image sensors 164, one or more proximity sensors 166, and one or more accelerometers 168. Device 100 may include components not shown in FIG. 1.

Device 100 is only one example of an electronic device, and device 100 may have more or fewer components than listed above, some of which may be combined into a single component or have a different configuration or arrangement. The various components of device 100 listed above are embodied in hardware, software, firmware or a combination thereof, including one or more signal processing and/or application-specific integrated circuits (ASICs).

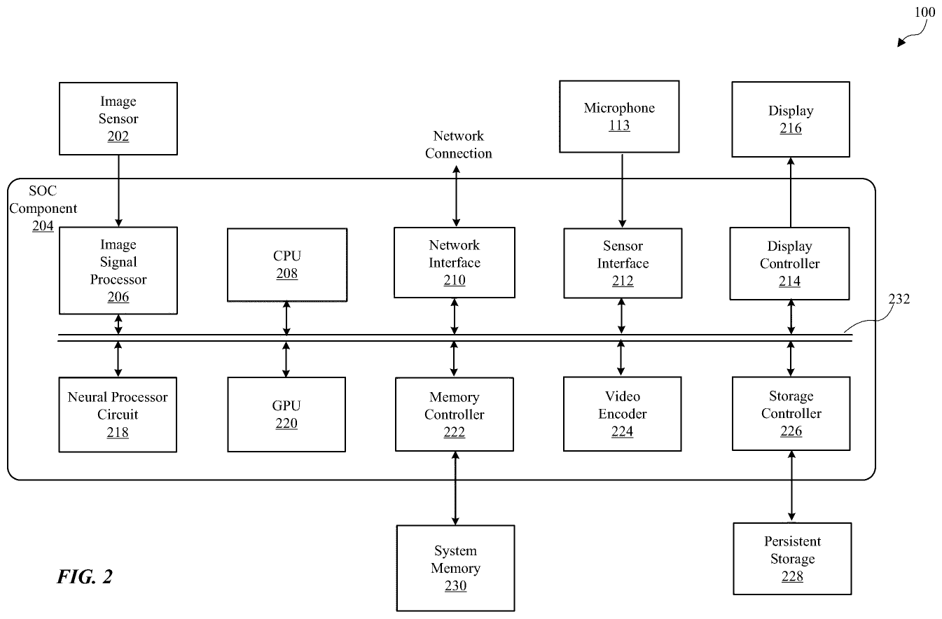

FIG. 2 is a block diagram illustrating components in device 100, according to some embodiments. Device 100 may perform various operations including image processing. For this and other purposes, device 100 may include, among other components, image sensor 202, system-on-a chip (SOC) component 204, system memory 230, persistent storage (e.g., flash memory) 228, microphone 113, and display 216. The components as illustrated in FIG. 2 are merely illustrative. For example, device 100 may include other components (such as a speaker) that are not illustrated in FIG. 2. Further, some components (such as display 216) may be omitted from device 100.

Image sensor 202 is a component for capturing image data and may be embodied, for example, as a complementary metal-oxide-semiconductor (CMOS) active-pixel sensor in a camera, video camera, or other devices. Image sensor 202 generates raw image data that is sent to SOC component 204 for further processing.

Display 216 is a component for displaying images as generated by SOC component 204. Display 216 may include, for example, liquid crystal display (LCD) device, an organic light emitting diode (OLED) device or micro-LED device. Based on data received from SOC component 204, display 216 may display various images, such as menus, selected operating parameters, images captured by image sensor 202 and processed by SOC component 204, and/or other information received from a user interface of device 100 (not shown).

System memory 230 is a component for storing instructions for execution by SOC component 204 and for storing data processed by SOC component 204. System memory 230 may be embodied as any type of memory including, for example, dynamic random access memory (DRAM), synchronous DRAM (SDRAM), double data rate (DDR, DDR2, DDR3, etc.) RAMBUS DRAM (RDRAM), static RAM (SRAM) or a combination thereof. In some embodiments, system memory 230 may store pixel data or other image data or statistics in various formats. In some embodiments, system memory 230 includes a compiler 336. Compiler 336 is architected to generate machine code for programming various parts of SOC component 204, as will be further described below.

Persistent storage 228 is a component for storing data in a non-volatile manner. Persistent storage 228 retains data even when power is not available. Persistent storage 228 may be embodied as read-only memory (ROM), flash memory or other non-volatile random access memory devices.

SOC component 204 is embodied as one or more integrated circuit (IC) chips and performs various data processing operations. SOC component 204 may include, among other subcomponents, image signal processor (ISP) 206, central processor unit (CPU) 208, network interface 210, sensor interface 212, display controller 214, neural processor circuit 218, graphics processor (GPU) 220, memory controller 222, video encoder 224, storage controller 226, and bus 232 connecting these subcomponents. SOC component 204 may include more or fewer subcomponents than those shown in FIG. 2.

ISP 206 is hardware that performs various stages of an image processing pipeline. In some embodiments, ISP 206 may receive raw image data from image sensor 202, and process the raw image data into a form that is usable by other subcomponents of SOC component 204 or components of device 100. ISP 206 may perform various image-manipulation operations such as image translation operations, horizontal and vertical scaling, color space conversion and/or image stabilization transformations.

CPU 208 may be embodied using any suitable instruction set architecture, and may be configured to execute instructions defined in that instruction set architecture. CPU 208 may be general-purpose or embedded processors using any of a variety of instruction set architectures (ISAs), such as the x86, PowerPC, SPARC, RISC, ARM or MIPS ISAs, or any other suitable ISA. Although a single CPU is illustrated in FIG. 2, SOC component 204 may include multiple CPUs. In multiprocessor systems, each of the CPUs may commonly, but not necessarily, implement the same ISA.

Graphics processing unit (GPU) 220 is graphics processing circuitry for performing graphical data. For example, GPU 220 may render objects to be displayed into a frame buffer (e.g., one that includes pixel data for an entire frame). GPU 220 may include one or more graphics processors that may execute graphics software to perform a part or all of the graphics operation, or hardware acceleration of certain graphics operations.

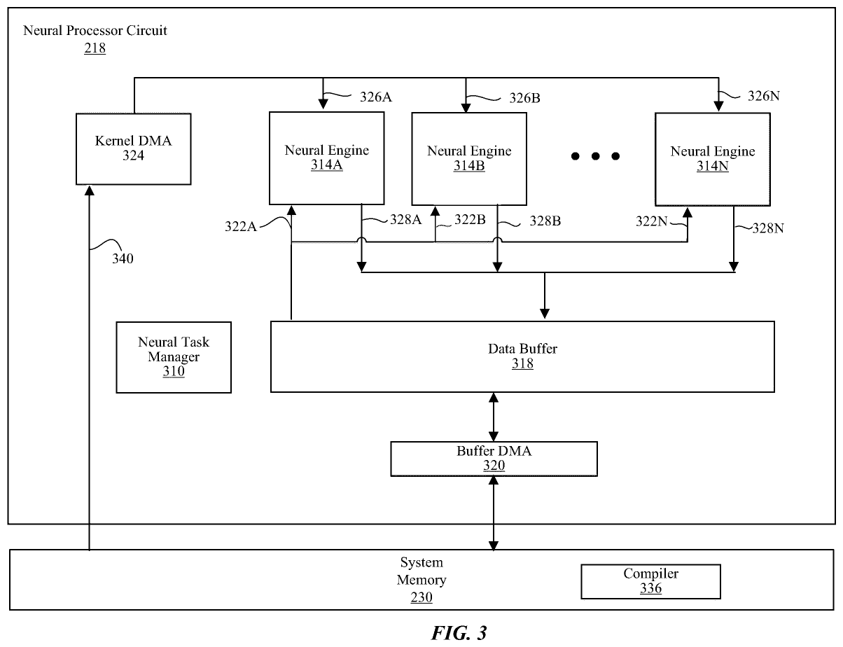

Neural processor circuit 218 is a circuit that performs various machine learning operations based on computations including multiplication, addition and accumulation. Such computations may be arranged to perform, for example, convolution operations on input data using kernel data. Neural processor circuit 218 is a configurable circuit that performs these operations in a fast and power-efficient manner while relieving CPU 208 of resource-intensive operations associated with neural network operations. Neural processor circuit 218 may receive the input data from sensor interface 212, the image signal processor 206, system memory 230 or other sources such as network interface 210 or GPU 220. The output of neural processor circuit 218 may be provided to various components of device 100 such as the image signal processor 206, system memory 230 or CPU 208 for various operations. The structure and operation of neural processor circuit 218 are described below in detail with reference to FIG. 3.

Network interface 210 is a subcomponent that enables data to be exchanged between devices 100 and other devices via one or more networks (e.g., carrier or agent devices). For example, video and other image data or audio data may be received from other devices via network interface 210 and be stored in system memory 230 for subsequent processing and display. The networks may include, but are not limited to, Local Area Networks (LANs) (e.g., an Ethernet or corporate network) and Wide Area Networks (WANs).

Sensor interface 212 is circuitry for interfacing with motion sensor 234. Sensor interface 212 receives sensor information from various types of sensors (e.g., microphone 113) and processes the sensor information. The sensor information may be sent to other subcomponents of SOC component 204 (e.g., neural processor circuit 218) for further processing.

Display controller 214 is circuitry for sending image data to be displayed on display 216. Display controller 214 receives the image data from ISP 206, CPU 208, graphic processor or system memory 230 and processes the image data into a format suitable for display on display 216.

Memory controller 222 is circuitry for communicating with system memory 230. Memory controller 222 may read data from system memory 230 for processing by ISP 206, CPU 208, GPU 220 or other subcomponents of SOC component 204. Memory controller 222 may also write data to system memory 230 received from various subcomponents of SOC component 204.

Video encoder 224 is hardware, software, firmware or a combination thereof for encoding video data into a format suitable for storing in persistent storage 128 or for passing the data to network interface 210 for transmission over a network to another device.

In some embodiments, one or more subcomponents of SOC component 204 or some functionality of these subcomponents may be performed by software components executed on ISP 206, CPU 208 or GPU 220. Such software components may be stored in system memory 230, persistent storage 228 or another device communicating with device 100 via network interface 210.

Image data or video data may flow through various data paths within SOC component 204. In one example, raw image data may be generated from the image sensor 202 and processed by ISP 206, and then sent to system memory 230 via bus 232 and memory controller 222. After the image data is stored in system memory 230, it may be accessed by video encoder 224 for encoding or by display 116 for displaying via bus 232.

### Example Neural Processor Circuit

Neural processor circuit 218 is a configurable circuit that performs neural network operations on the input data based at least on kernel data. For this purpose, neural processor circuit 218 may include, among other components, neural task manager 310, neural engines 314A through 314N (hereinafter collectively referred as “neural engines 314” or individually as “neural engine 314”), kernel direct memory access (DMA) 324, data buffer 318, and buffer DMA 320. Neural processor circuit 218 may include other components not illustrated in FIG. 3 such as a separate circuit for performing specialized computation operations.

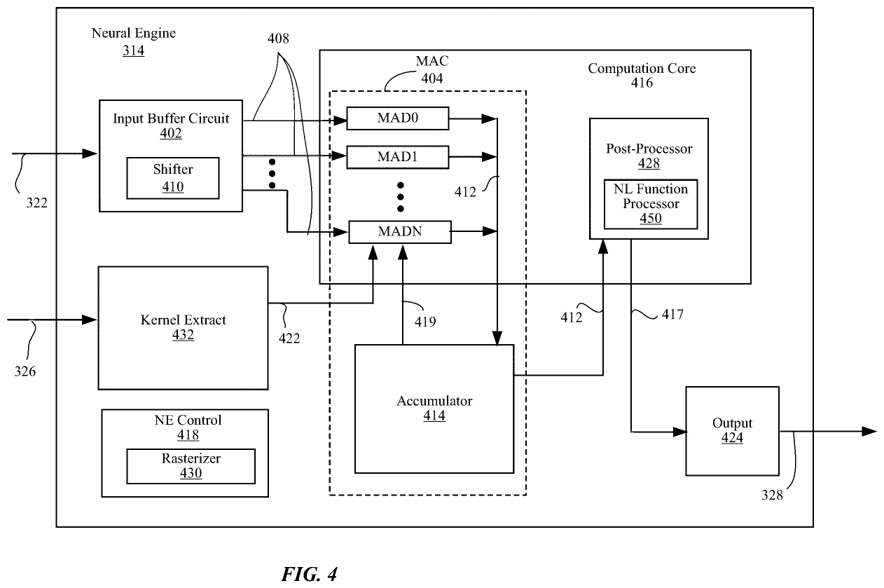

Each of neural engines 314 performs computing operations for neural network operations in parallel. Depending on the load of operation, an entire set of neural engines 314 may be operated or only a subset of the neural engines 314 may be operated while the remaining neural engines 314 are placed in a power save mode to conserve power. Each of neural engines 314 includes components for storing one or more kernels, for performing multiply-accumulate operations, and for post-processing to generate output data 328, as described below in detail with reference to FIG. 4. One example of a neural network operation is a convolution operation followed by application of a bias and an activation function on the result of the convolution operation.

Neural task manager 310 manages the overall operation of neural processor circuit 218. Neural task manager 310 may receive a task list from compiler 336 executed by CPU 208, store tasks in its task queues, choose a task to perform, and send instructions to other components of the neural processor circuit 218 for performing the chosen task. Neural task manager 310 may also perform switching of tasks on detection of events such as receiving instructions from CPU 208. In some embodiments, the neural task manager 310 sends rasterizer information to the components of the neural processor circuit 218 to enable each of the components to track, retrieve or process appropriate portions of the input data and kernel data. Although neural task manager 310 is illustrated in FIG. 3 as part of neural processor circuit 218, neural task manager 310 may be a component outside the neural processor circuit 218.

Kernel DMA 324 is a read circuit that fetches kernel data from a source (e.g., system memory 230) and sends kernel data 326A through 326N to each of the neural engines 314. Kernel data represents information from which kernel elements can be extracted. In some embodiments, the kernel data may be in a compressed format which is decompressed at each of neural engines 314. Although kernel data provided to each of neural engines 314 may be the same in some instances, the kernel data provided to each of neural engines 314 is different in most instances.

Data buffer 318 is a temporary storage for storing data associated with the neural network operations. In some embodiments, data buffer 318 is embodied as a memory that can be accessed by all of the neural engines 314. Data buffer 318 may store input data received from system memory 230, input data 322A through 322N for feeding to corresponding neural engines 314A through 314N, as well as output data from each of neural engines 314A through 314N for feeding back into neural engines 314 or sending to a target circuit (e.g., system memory 230). The operations of data buffer 318 and other components of the neural processor circuit 218 are coordinated so that the input data and intermediate data stored in the data buffer 318 is reused across multiple operations at the neural engines 314, and thereby reducing data transfer to and from system memory 230. Data buffer 318 may be operated in a broadcast mode where input data of all input channels are fed to all neural engines 314 or in a unicast mode where input data of a subset of input channels are fed to each neural engine 314.

Buffer DMA 320 includes a read circuit that receives a portion of the input data from a source (e.g., system memory 230) for storing in data buffer 318, and a write circuit that forwards data from data buffer 318 to a target (e.g., system memory).

### Example Neural Engine Architecture

FIG. 4 is a block diagram of neural engine 314, according to some embodiments. Neural engine 314 performs various operations to facilitate neural network operations such as convolution, spatial pooling and local response normalization. Neural engine 314 receives input data 322, performs multiply-accumulate operations (e.g., convolution operations) on input data 322 based on stored kernel data, performs further post-processing operations on the result of the multiply-accumulate operations, and generates output data 328. Input data 322 and/or output data 328 of neural engine 314 may be of a single channel or multiple channels that are in a width-last format.

Neural engine 314 may include, among other components, input buffer circuit 402, computation core 416, neural engine (NE) control 418, kernel extract circuit 432, accumulators 414 and output circuit 424. Neural engine 314 may include other components not illustrated in FIG. 4.

Input buffer circuit 402 is a circuit that stores a portion of input data 322 as it is received from the data buffer 318 and sends an appropriate portion 408 of input data for a current task or process loop to computation core 416 for processing. Input buffer circuit 402 includes a shifter 410 that shifts read locations of input buffer circuit 402 to change the portion 408 of input data sent to computation core 416. By changing portions of input data provided to the computation core 416 via shifting, neural engine 314 can perform multiply-accumulate for different portions of input data based on fewer read operations. Depending on the modes of operation, input data 322 stored in input buffer circuit 402 may have different data layout format.

Kernel extract circuit 432 is a circuit that receives kernel data 326 from kernel DMA 324 and extracts kernel coefficients 422. In some embodiments, kernel extract circuit 432 references a look-up table (LUT) and uses a mask to reconstruct a kernel from compressed kernel data 326.

Computation core 416 is a programmable circuit that performs computation operations. For this purpose, computation core 416 may include MAD circuits MAD0 through MADN, and a post-processor 428. Each of MAD circuits MAD0 through MADN may store an input value in the portion 408 of the input data and a corresponding kernel coefficient in the kernel coefficients 422. The input value and the corresponding kernel coefficient are multiplied in each of MAD circuits to generate a processed value 412.

Accumulator 414 is a memory circuit that receives and stores processed values 412 from MAD circuits. The processed values stored in accumulator 414 may be sent back as feedback information 419 for further multiply and add operations at MAD circuits or sent to post-processor 428 for post-processing. Accumulator 414 in combination with MAD circuits form a multiply-accumulator (MAC) 404.

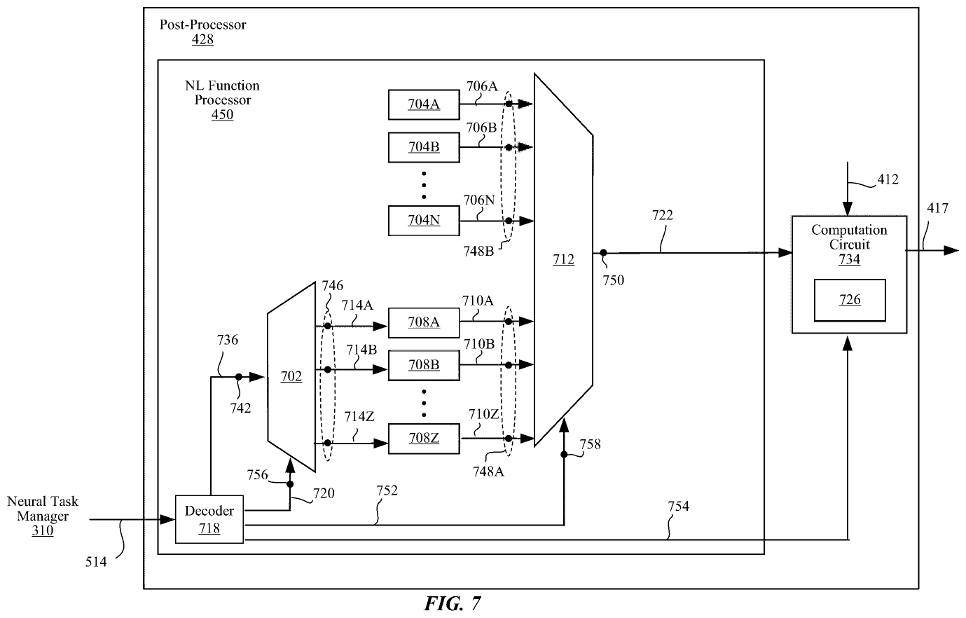

Post-processor 428 is a circuit that performs further processing of values 412 received from accumulator 414. The post-processor 428 may perform operations including, but not limited to, applying nonlinear functions (e.g., Rectified Linear Unit (ReLU)), normalized cross-correlation (NCC), merging the results of performing neural operations on 8-bit data into 16-bit data, and local response normalization (LRN). The result of such operations is output from the post-processor 428 as activation values 417 to output circuit 424. To store parameters representing the nonlinear functions for deriving activation functions, post-processor 428 includes nonlinear (NL) function processor 450. NL function processor 450 is described below in detail with reference to FIG. 7.

NE control 418 controls operations of other components of the neural engine 314 based on the operation modes and parameters of neural processor circuit 218. Depending on different modes of operation (e.g., group convolution mode or non-group convolution mode) or parameters (e.g., the number of input channels and the number of output channels), neural engine 314 may operate on different input data in different sequences, return different values from accumulator 414 to MAC circuits, and perform different types of post-processing operations at post-processor 428. To configure components of the neural engine 314 to operate in a desired manner, the NE control 418 sends a control signal including configuration information to components of the neural engine. NE control 418 may also include rasterizer 430 that tracks the current task or process loop being processed at neural engine 314.

Output circuit 424 receives activation values 417 from the post-processor 428 and interfaces with data buffer 318 to store activation values 417 in data buffer 318. For this purpose, output circuit 424 may send out output data 328 in a sequence or a format that is different from the sequence or format in which the activation values 417 are processed in post-processor 428.

The components in the neural engine 314 may be configured during a configuration period by the NE control 418 and the neural task manager 310. For this purpose, the neural task manager 310 sends configuration data to the neural engine 314 during the configuration period. The configurable parameters and modes may include, but are not limited to, mapping between input data elements and kernel elements, setting the number of input channels and the number of output channels, performing of output strides, and enabling /election of post-processing operations at post-processor 428.

### Example Neural Task Manager Architecture

A neural network may include network layers or sub-layers that are instantiated or implemented as a series of tasks executed by neural processor circuit 218. A neural network is converted, such as by compiler 336, to a task list. Each task is associated with a task descriptor that defines the configuration of the neural processor circuit 218 to execute the task. Each task may correspond with a single network layer of the neural network, a portion of a network layer of the neural network, or multiple network layers of the neural network. The neural processor circuit 218 instantiates the neural network by executing the tasks of the task list under the control of neural task manager 310.

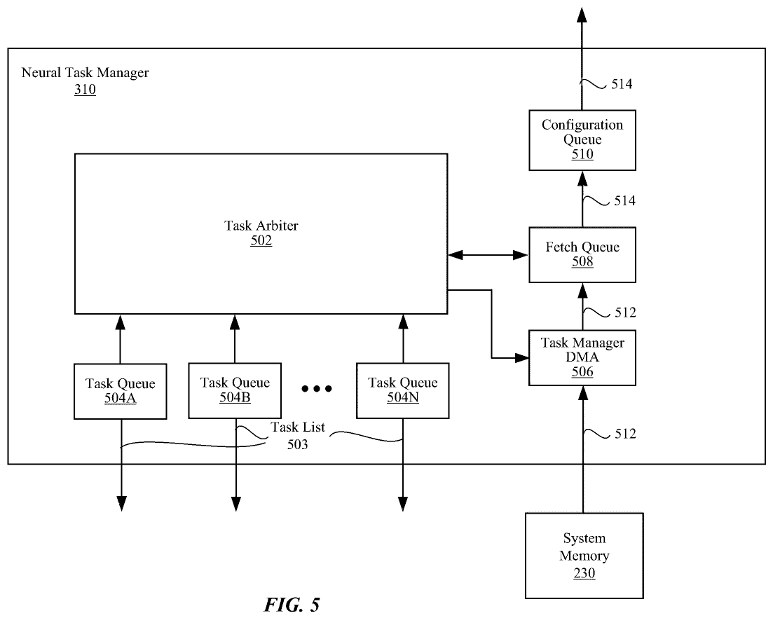

FIG. 5 is a block diagram illustrating neural task manager 310, according to some embodiments. Neural task manager 310 manages the execution of tasks for one or more neural networks by neural processor circuit 218. Neural task manager 310 may include, among other components, a task arbiter 502, task queues 504A through 504N (hereinafter collectively referred as “task queues 504” or individually as “task queue 504”), a task manager direct memory access (DMA) 506, a fetch queue 508, and a configuration queue 510. Neural task manager 310 may include other components not illustrated in FIG. 5.

Task arbiter 502 is a circuit or a combination of circuit and firmware that selects tasks from task queues 504 for execution by neural processor circuit 218. Task arbiter 502 dequeues tasks from task queues 504, and places tasks in the configuration queue 510. While a task is in a configuration queue, it is committed to execution and the neural processor circuit performs a prefetch for input data and kernel data before the task is executed by other components of the neural processor circuit 218. For example, the task arbiter 502 may perform fixed-priority arbitration between multiple task queues 504, and select the task from task queues 504 with the highest priority for retrieval of a task descriptor 512 from the system memory 230 by the task manager DMA 506.

Neural task manager 310 may include one or more task queues 504. Each task queue 504 is coupled to the CPU 208 and task arbiter 502. Each task queue 504 receives from the CPU 208 a reference to a task list that when executed by neural processor circuit 218 instantiates a neural network or a part of the neural network. The reference stored in each task queue 504 may include a set of pointers and counters pointing to task descriptors 512 stored in the system memory 230. Each task queue 504 may be further associated with a priority parameter that defines the relative priority of the task queues 504. The task descriptor of a task specifies, among other things, the configuration of neural processor circuit 218 for executing the task.

Task manager DMA 506 is coupled to task arbiter 502, system memory 230, and fetch queue 508. Task manager DMA 1006 includes a read circuit that receives task descriptors 512 of tasks from a source (e.g., system memory 230) for storing in fetch queue 508. For example, task arbiter 502 selects a task queue 504 according to the priorities of task queues 504, and uses the task list referenced by the selected task queue 504 to control the task manager DMA 506 to select the task descriptor 512 of a task.

Fetch queue 508 is a single entry queue that stores a task descriptor 512 of a task that is pending to commit for execution. Fetch queue 508 is coupled to task manager DMA 506 to receive task descriptor 512 from the system memory 230, and provides task descriptor 512 to configuration queue 510, or configuration data 514 extracted from task descriptor 512 to configuration queue 510.

Configuration queue 510 holds configuration data 514 of multiple tasks that have been committed for execution. When a task is in configuration queue 510, kernel DMA 324 may fetch kernel data from system memory 230 to store in kernel extract circuit 432 of neural engines 314, and buffer DMA 320 may fetch input data from system memory 230 to store in the data buffer 318. To execute the task, kernel extract circuit 432 provides the prefetched kernel data to MAC 404 of neural engine 314, and data buffer 318 provides the prefetched input data to MAC 404 of neural engine 314. In some embodiments, configuration queue 510 may include multiple queues that hold configuration data 514 extracted from the committed task descriptors 512. Configuration queue 510 is further coupled to other components of the neural processor circuit 218 to configure neural processor circuit 218 according to configuration data 514. Configuration data 514 is sent to components of neural processor circuit 218 to program these components for a corresponding task.

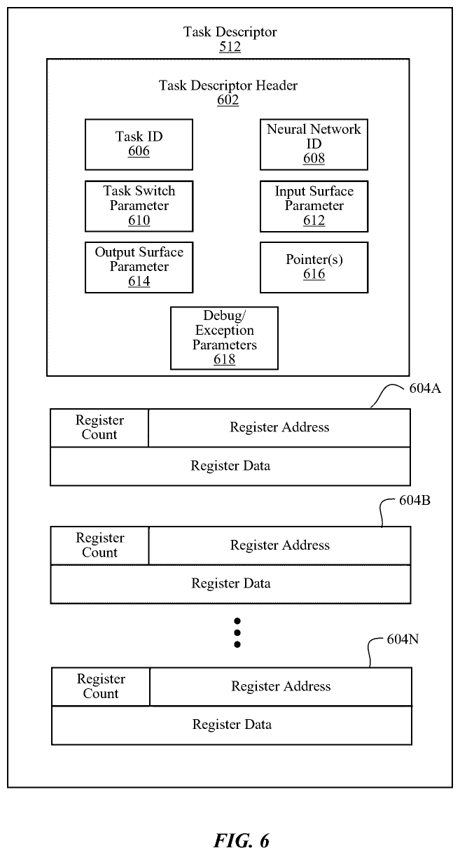

FIG. 6 is a diagram illustrating task descriptor 512, according to some embodiments. The task arbiter 502 places task descriptor 512 in fetch queue 508 from system memory 230, which is then transferred to configuration queue 510. The highest priority (e.g., first in) task descriptor 512 in configuration queue 510 is used to configure the neural processor circuit 218 for execution during the configuration period. The task descriptor 512 includes configuration data 514 including a task descriptor header 602 and address data 604A through 604N (hereinafter referred as “address data 604”). Task descriptor header 602 includes configuration data that configures various operations of the neural task manager 310, including operations related to task selection and task switching. For example, task descriptor header 602 may be parsed by task arbiter 502 to extract configuration data that programs neural task manager 310 and other components of neural processor circuit 218. Task descriptor header 602 may include a task identifier (ID) 606 that identifies the task, a neural network identifier (ID) 608 that identifies a neural network instantiated by the task, a task switch parameter 610 defining whether neural task manager 310 should initiate a task switch (e.g., to execute a task of a different task queue 504 after execution of the task, an input surface parameter 612 defining whether the input data for the task should be retrieved from the system memory 230 or the data buffer 318, an output surface parameter 614 defining whether the output data of the task should be stored in the system memory 230 or the data buffer 318, various (e.g., base address) pointers 616 to facilitate the programming of the neural processor circuit 218, and one or more debug/exception parameters 618 that control event, exception, or debug logging.

Each instance of address data 604A through 604N (collectively or individually referred to as “address data 604”) defines an address and data payload pair used to program the components of the neural processor circuit 218. The data payload may indicate, among other things, parameters representing nonlinear functions from which activation functions may be derived or an index indicating a programmable or nonprogrammable memory circuit storing the parameters representing a nonlinear function to be used for deriving an activation function in the task corresponding to the task descriptor.

### Example Nonlinear Function Processor

In some cases, different tasks use different activation functions to perform operations on processed values 412 received from MAC 404. Conversely, in other cases, the same set of activation functions are repeatedly used across different tasks. For example, if multiple tasks are parts of the same ANN layer, these tasks may share the same set of activation functions. Regardless of whether the activation functions are used in only one task or reused across multiple tasks, a task descriptor for each task provides information on the activation functions to be used in post-processor 428.

One way of indicating the activation functions is to include parameters for deriving the activation functions in each of the task descriptors regardless of whether the same activation functions are used across multiple tasks. However, including parameters in all task descriptors may be redundant and unnecessarily increase the collective size of the task descriptors. Hence, embodiments provide NL function processor 450 that is programmed with parameters of nonlinear functions (from which the activation functions are derived). NL function processor 450 retains the parameters for use across different tasks until a subsequent task using different nonlinear functions associated with updated parameters is executed. The parameters stored in NL function processor 450 may be updated for execution of the subsequent task. In this way, task descriptors may omit the parameters for the nonlinear functions if a prior task descriptor included the parameters and stored them in NL function processor 450, and thereby reduce the overall size of the task descriptors.

Post-processor 428 may include, among other components, NL function processor 450 and computation circuit 734. FIG. 7 is a block diagram illustrating NL function processor 450 in post-processor 428, according to some embodiments. NL function processor 450 stores parameters of nonlinear functions, corresponding to activation functions or from which the activation functions may be derived. The stored parameters are selectively sent to computation circuit 734 to construct an activation function and enable processed values 412 received from MAC 404 to be applied to the activation function. Once computation circuit 734 receives the selected parameters from NL function processor 450, computation circuit 734 determines activation values 417 corresponding to processed values 412 by applying processed values 412 to the activation function with or without applying bias values.

NL function processor 450 may be a hardware circuit that includes, among other components, decoder circuit 718, demultiplexer 702, nonprogrammable memory circuits 704A through 704N (hereinafter collectively referred to also as “nonprogrammable memory circuits 704” or individually as “nonprogrammable memory circuit 704”), programmable memory circuits 708A through 708Z (hereinafter collectively referred to also as “programmable memory circuits 708” or individually as “programmable memory circuit 708”), and multiplexer 712. NL function processor 450 may include other components not illustrated in FIG. 7, such as data buffers.

Decoder circuit 718 is a circuit that parses configuration data 514 and extracts parameters 736 for a nonlinear function (if included in configuration data 514), and selection signals 720, 752, 754. Configuration data 514 may indicate, among other things, the following: (i) which of the programmable memory circuits 708 are to be programmed, if any, with parameters 736 extracted from configuration data 514, (ii) from which of the programmable or nonprogrammable memory circuits parameters for the nonlinear function are to be retrieved, if any, for sending to computation circuit 734, and (iii) whether a dedicated circuit in computation circuit 734 for computing the nonlinear function is to be used instead of relying on selected parameters 722. Decoder circuit 718 parses configuration data 514 and forwards parameters 736 and/or selection signals 720, 752, 754 to demultiplexer 702, multiplexer 712 and computation circuit 734. In some embodiments, decoder circuit 718 may be located outside post-processor 428 or neural engine 314.

Demultiplexer 702 is a circuit that forwards parameters 736 received at its input terminal 742 to one of programmable memory circuits 708 via one of its output terminals 746 according to selection signal 720 received at its control terminal 756. Each of output terminals 746 may be connected to a corresponding programmable memory circuit 708 so that sets of parameters 714A through 714Z may be sent to respective programmable memory circuits 708. If configuration data 514 indicates that none of programmable memory circuits 708 is to be updated in the current task, decoder circuit 718 does not send selection signal 720 to demultiplexer 702 and the process of updating of parameters in programmable memory circuits 708 is skipped in the current task.

Nonprogrammable memory circuits 704 are memory circuits pre-programmed with parameters of nonlinear functions and may not be programmed with updated parameters. Nonprogrammable memory circuits 704 may be implemented as Read-Only Memory (ROM) or other non-volatile random access memory devices. Nonprogrammable memory circuits 704 store sets of parameters 706A through 706N for nonlinear functions that are often used in tasks. In some embodiments, each of nonprogrammable memory circuits 704 stores a set of parameters for a different nonlinear function. Each set of parameters 706A through 706N may be stored in one of nonprogrammable memory circuits 704 in the form of a look-up table (LUT). In some embodiments, more than one nonprogrammable memory circuit 704 may be used to store parameters for a single nonlinear function in the form of a LUT.

Programmable memory circuits 708 are memory circuits that are repeatedly programmable with parameters representing different nonlinear functions. Programmable memory circuits 708 may be embodied as, for example, dynamic random access memory (DRAM), synchronous DRAM (SDRAM), double data rate (DDR, DDR2, DDR3, etc.) RAMBUS DRAM (RDRAM), static RAM (SRAM), or a combination thereof. Some tasks may involve unique or infrequently used nonlinear functions. Sets of parameters for such nonlinear functions may not be available from programmable memory circuits 708. In such a case, the sets of parameters for the nonlinear functions are received from decoder circuit 718 via demultiplexer 702 and are stored in programmable memory circuits 708. The parameters stored in programmable memory circuits 708 may be retrieved and be repeatedly used across multiple tasks until subsequent tasks involving different nonlinear functions are to be executed. When the subsequent tasks use new nonlinear functions, at least some of programmable memory circuits 708 may be reprogrammed with updated parameters for retrieval during the execution of the subsequent tasks. Each set of parameters 710A through 710Z may be stored in one of programmable memory circuits 708 in the form of a LUT. In some embodiments, more than one nonprogrammable memory circuit 708 may be used to store parameters for a single nonlinear function in the form of a LUT. Alternatively, a single nonprogrammable memory circuit may be used to store multiple sets of parameters 710A through 710N.

In some embodiments, the number of nonprogrammable memory circuits 704 is larger than the number of programmable memory circuits 708. Nonprogrammable memory circuits 704 take up less space compared to programmable memory circuits 708. Hence, parameters of widely used nonlinear functions may be prestored in nonprogrammable memory circuits 704 to reduce the space associated with providing programming programmable memory circuits 708.

Multiplexer 712 is a circuit that selects a set of parameters stored in one of nonprogrammable memory circuits 704 and programmable memory circuits 708, and forwards the selected set of parameters to computation circuit 734. For this purpose, multiplexer 712 includes first input terminals 748A, second input terminals 748B, control terminal 758 and output terminal 750. First input terminals 748A are connected to programmable memory circuits 708 to receive sets of parameters 710A through 710Z from programmable memory circuits 708. Second input terminals 748B are connected to nonprogrammable memory circuits 704 to receive sets of parameters 706A through 706N stored in nonprogrammable memory circuits 704. Control terminal 758 of multiplexer 712 receives selection signal 752 indicating the memory circuits from which the sets of parameters 706, 710 are to be retrieved and sent as selected set of parameters 722 to computation circuit 734 via output terminal 750. Selection signal 752 may be an index indicating one of memory circuits 704, 708 that store selected set of parameters 722.

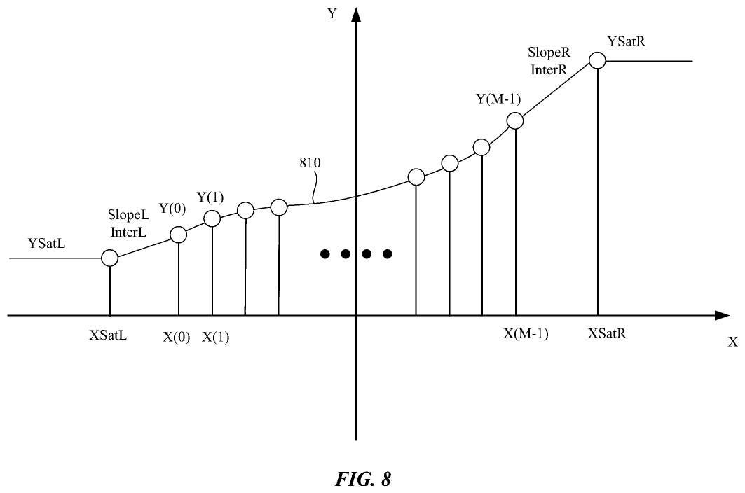

Computation circuit 734 is a circuit that generates activation values 417 by applying processed value 412 to an activation function. Computation circuit 734 may receive selected set of parameters 722 representing a nonlinear function, and use the nonlinear function as the activation function or derive an activation function from the nonlinear function. After an input to the activation function is determined by, for example, applying a bias value to processed values 412, computation circuit 734 may determine activation value 417 corresponding to the determined input by interpolating the output values mapped by a nonlinear function to two discretized input values that are closest to the determined input. Example parameters are described below in detail with reference to FIG. 8.

Computation circuit 734 may include one or more dedicated circuits 726 that implement nonlinear functions. Some nonlinear functions, such as Rectified Linear Unit (ReLU), may be implemented using a digital circuit, an analog circuit, or a combination thereof. These circuits may be relatively simple to implement and may be used in place of or in addition to selected parameters 722 to approximate a nonlinear function. In some embodiments, when dedicated circuits 726 are used, selected parameters 722 are not received from NL function processor 450 or are disregarded.

Selection signal 754 is received at computation circuit 734 to configure its operations. Selection signal 754 may indicate, among other things, whether dedicated circuits 726 are to be used to generate activation values 417, and if so, which one of the dedicated circuits 726 is to be used. Further, selection signal 754 may also indicate circuit parameters for setting and controlling one or more dedicated circuits 726. For example, the circuit parameters may indicate a scaling factor to be applied to outputs from dedicated circuits 726 to generate the activation values. If selection signal 754 indicates that dedicated circuits 726 are not to be used, computation circuit 734 may approximate a nonlinear function using selected parameters 722. Selection signal 754 may also include information used for parts other than dedicated circuits 726. For example, selection signal 754 may indicate a bias value to be applied to processed values 412.

In some embodiments, a single nonprogrammable memory circuit may be used to store multiple sets of parameters 706A through 706N. In addition or alternatively, a single nonprogrammable memory circuit may be used to store multiple sets of parameters 710A through 710Z. In these embodiments, selection signals 720, 752 further indicate memory locations on the memory circuit where a set of parameters are to be updated or to be retrieved.

The components of post-processor 428 and NL function processor 450, and their arrangements as illustrated in FIG. 7 are merely illustrative. Post-processor 428 and NL function processor 450 may include other components. For example, post-processor 428 may include additional components to perform element-wise operations or pooling operations on tensors. Further, NL function processor 450 may include only programmable memory circuits 708 and not any nonprogrammable memory circuits 704.

### Example Parameters of Nonlinear Function

FIG. 8 is a graph illustrating example nonlinear function 810, according to some embodiments. In the graph of FIG. 8, the x-value represents the input to nonlinear function 810, while the corresponding y-value represents the output of nonlinear function 810. The relationship between the x-values and y-values illustrates how nonlinear function 810 maps inputs to outputs. Nonlinear function 810 may be used as an activation function or be modified to obtain an activation function.

In FIG. 8, M number of discretized input values X(0), X(1) . . . X(M−1) to nonlinear function 810 and a corresponding number of discretized output values Y(0), Y(1) . . . Y(M−1) of nonlinear function 810, and two input saturation points (XSatL, YSatL), (XSatR, YSatR) are illustrated. All output values of nonlinear function 810 at or beyond saturation point (XSatL, YSatL) to the left are YSatL while all the output values of nonlinear function 810 at or beyond saturation point (XSatR, YSatR) to the right are YSatR. Nonlinear function 810 includes a straight line between saturation point (XSatL, YSatL) and point (X0, Y0), defined by slope value SlopeL and a y-intercept value InterL. Nonlinear function 810 further includes another straight line between saturation point (XSatR, YSatR) and point (X(M−1), Y(M−1)), defined by slope value SlopeR and a y-intercept value InterR.

In some embodiments, the parameters that define a nonlinear function include, among other things, x-coordinate of the left saturation point (e.g., XSatL), y-coordinate of the left saturation point (e.g., YSatL), x-coordinate of the right saturation point (e.g., XSatR), y-coordinate of the right saturation point (e.g., YSatR), slope values (e.g., SlopeL and SlopeR), y-intercept values (e.g., InterL and InterR), and output values (e.g., Y(0), Y(1) . . . Y(M−1)) corresponding to discretized input values. The parameters may also include a mode field indicating different modes of deriving an activation function from other parameters. For example, in one mode, the activation function may be an interpolated version of nonlinear function where the output values are interpolated from adjacent discretized output values (e.g., Y(0), Y(1) . . . Y(M−1)) while in another mode, the activation function may be an inverse of the nonlinear function represented by the parameters. In yet another mode, the output values from the left side of the nonlinear function and output values of the right side of the nonlinear function are alpha-blended to obtain the output values of the activation function. Depending on the mode, some of the parameters may have a null value or be disregarded when deriving the activation function.

The examples of parameters and the generation of the activation function from the nonlinear function described above with reference to FIG. 8 are merely illustrative. Nonlinear functions of various other shapes may be used, and different sets of parameters may be used to define the nonlinear functions. For example, only one saturation point may be used at one end of a nonlinear function.

### Example Operation in Post-Processor

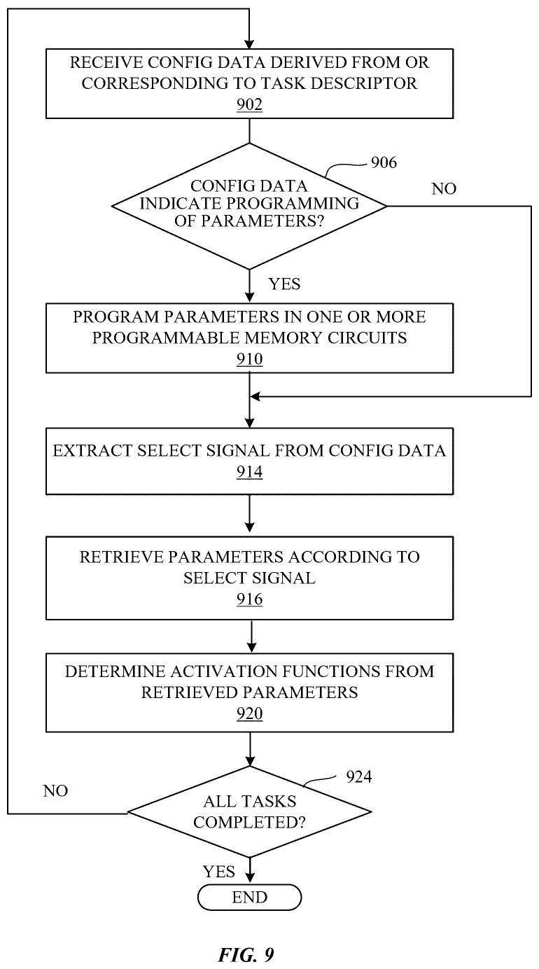

FIG. 9 is a flowchart illustrating a method of operating NL function processor 450 in neural processor circuit 218, according to some embodiments. NL function processor 450 receives configuration data 514 derived from or corresponding to a task descriptor of a current task, as described above with reference to FIG. 5.

It is determined 906 whether configuration data 514 indicates programming of parameters in one or more programmable memory circuits 708. If configuration data 514 indicates programming of the parameters, then the process proceeds to program 910 one or more programmable memory circuits 708 with one or more sets of parameters, as indicated by configuration data 514. Each set of parameters may represent a nonlinear function, and may be stored in one of programmable memory circuits 708 in the form of a LUT. If only a subset of programmable memory circuits 708 are to be programmed by configuration data 514, then configuration data 514 may indicate the subset of programmable memory circuits 708 to be programmed. Programmable memory circuits 708 other than ones indicated by configuration data 514 may retain stored parameters without updating them.

A set of parameters defines a nonlinear function and may include one or more of: coordinates of saturation points, slope values and intercept values of linear sections of the nonlinear function, and output values corresponding to discretized input values, and a mode of deriving an activation function. Various other sets of parameters may also be used to define a nonlinear function.

If configuration data 514 does not indicate programming of the parameters, then the process proceeds to extracting 914 selection signal 752 from control data 514 without programming 910 the parameters. In this case, the parameters programmed in a previous task may be reused in the current task. Hence, the task descriptor of the current task may omit the parameters and instead include an index for generating selection signal 752. Selection signal 752 indicates which one of memory circuits 704, 708 is to be selected for retrieving a set of parameters.

Then the process proceeds to retrieve 916 a set of parameters from nonprogrammable memory circuit 704 or programmable memory circuit 708, as indicated by selection signal 752. The retrieved set of parameters may be sent via multiplexer 712 to computation circuit 734.

One or more activation functions corresponding to the retrieved parameters may be determined 920 by computation circuit 734. Each set of retrieved parameters may represent a nonlinear function which corresponds to an activation function or from which the activation function may be derived. The activation function is used in computation circuit 734 to determine activation values corresponding to processed values 412 by at least interpolating output values mapped by the nonlinear function to discretized input values.

Then it is determined 924 if all tasks are completed. If all tasks are completed, then the process terminates. If not all tasks are completed, then the process returns to receiving 902 configuration data and repeats the subsequent processes.

The steps and their sequence in FIG. 9 are merely illustrative and various changes may be made. For example, if the configuration data indicates that a dedicated circuit in the computation circuit for generating an output for a nonlinear function is to be used in lieu of selected parameters, the processes of extracting 914 select signals through determining 920 activation functions from the retrieved parameters may be omitted.

While particular embodiments and applications have been illustrated and described, it is to be understood that the invention is not limited to the precise construction and components disclosed herein and that various modifications, changes and variations which will be apparent to those skilled in the art may be made in the arrangement, operation and details of the method and apparatus disclosed herein without departing from the spirit and scope of the present disclosure.

What is claimed is:

1. A neural processor circuit, comprising:
at least one neural engine circuit, comprising:
a multiply-accumulate (MAC) circuit configured to accumulate multiplied values to generate a processed value; and
a post-processor circuit coupled to the MAC circuit to receive the processed value, the post-processor circuit comprising:
at least one programmable memory circuit configured to receive and store parameters representing a first nonlinear function; and
a selector circuit configured to retrieve parameters from the at least one programmable memory circuit, the parameters representing a nonlinear function corresponding to an activation function to be applied with the processed value; and
a neural task manager circuit configured to send, to the post-processor circuit, first configuration data corresponding to a first task descriptor defining a configuration of the neural processor circuit to execute a current task, the configuration data including the selection of the at least one programmable memory circuit.

2. The neural processor circuit of claim 1, wherein the neural task manager is further configured to send, to the post-processor circuit, second configuration data corresponding to a second task descriptor defining a configuration of the neural processor circuit to execute a prior task preceding the current task.

3. The neural processor circuit of claim 2, wherein the parameters are retained in the at least one programmable memory circuit until execution of a subsequent task corresponding to a third task descriptor that indicates updating of the parameters.

4. The neural processor circuit of claim 2, wherein the post-processor circuit further comprises a demultiplexer, the demultiplexer comprising:
an input terminal configured to receive the parameters;
output terminals coupled to the at least one programmable memory circuit; and
a control terminal configured to receive a selection signal extracted from the second configuration data, the selection signal indicating selection of one of the output terminals through which the parameters are sent to the at least one programmable memory circuit for storing.

5. The neural processor circuit of claim 2, wherein the second task descriptor comprises a task descriptor header and address data fields, one of the address data fields including the parameters of the first nonlinear function.

6. The neural processor circuit of claim 1, wherein the post-processor circuit further comprises a plurality of non-programmable memory circuits, each of the non-programmable memory circuits configured to store parameters for a second nonlinear function.

7. The neural processor circuit of claim 6, wherein a number of the plurality of non-programmable memory circuits is larger than a number of the at least one programmable memory circuit.

8. The neural processor circuit of claim 6, wherein the selector circuit comprises a multiplexer, the multiplexer comprising:
at least one first input terminal coupled to the at least one programmable memory circuit;
second input terminals coupled to the plurality of non-programmable memory circuits;
a control terminal configured to receive a selection signal extracted from the first configuration data, the selection signal indicating selection of the at least one programmable memory circuit and the plurality of non-programmable memory circuits as a selected memory circuit; and
an output terminal configured to output parameters stored in the selected memory circuit.

9. The neural processor circuit of claim 8, wherein the post-processor circuit further comprises a decoder configured to receive the first configuration data from the neural task manager circuit and extract the selection signal from the configuration data.

10. The neural processor circuit of claim 1, wherein the post-processor circuit further comprises a computation circuit configured to:
receive the parameters from the selector circuit; and
determine a first activation value corresponding to a version of the processed value applied to the activation function by at least interpolating a subset of the parameters.

11. The neural processor circuit of claim 10, wherein the computation circuit comprises a dedicated circuit for computing a second activation value of the version of the processed value without using the parameters.

12. The neural processor circuit of claim 1, wherein the parameters for the first nonlinear function comprises a first saturation input boundary, a second saturation input boundary at an opposite side of the first saturation input boundary, and a plurality of output values of the first nonlinear function corresponding to input values between the first saturation input boundary and the second saturation input boundary.

13. A method of operating a neural processor circuit, comprising:
storing parameters representing at least one first nonlinear function in at least one programmable memory circuit;
receiving a selection extracted from first configuration data corresponding to a first task descriptor defining a configuration of the neural processor circuit to execute a current task;
retrieving selected parameters from the at least one programmable memory circuit based on the selection;
determining an activation function from the selected parameters;
accumulating multiplied values to generate a processed value; and
applying the activation function with the processed value to generate an activation value.

14. The method of claim 13, further comprising:
extracting the parameters of the at least one first nonlinear function from second configuration data corresponding to a second task descriptor defining a configuration of the neural processor circuit to execute a prior task preceding the current task; and
sending the extracted parameters to the at least one programmable memory circuit for storing.

15. The method of claim 14, further comprising retaining the parameters in the at least one programmable memory circuit until execution of a subsequent task corresponding to a third task descriptor that indicates updating of the parameters.

16. The method of claim 14, further comprising:
receiving the parameters by an input terminal of a demultiplexer;
receiving a selection signal derived from the second task descriptor by a control terminal of the demultiplexer; and
sending the parameters to the at least one programmable memory circuit by one of output terminals of the demultiplexer responsive to the selection signal indicating selection of the one of the output terminals.

17. The method of claim 13, further comprising storing parameters for second nonlinear functions in a plurality of non-programmable memory circuits.

18. The method of claim 17, wherein a number of the plurality of non-programmable memory circuits is larger than a number of the at least one programmable memory circuit.

19. The method of claim 17, further comprising:
receiving a selection signal derived from the first task descriptor by a control terminal of a multiplexer, the selection signal indicating selection of the at least one programmable memory circuit and the plurality of non-programmable memory circuit as a selected memory circuit; and
sending parameters stored in the selected memory circuit by output terminals of the multiplexer.

20. An integrated circuit (IC) system, comprising:
at least one neural engine circuit, comprising:
a multiply-accumulate (MAC) circuit configured to accumulate multiplied values to generate a processed value; and
a post-processor circuit coupled to the MAC circuit to receive the processed value, the post-processor circuit comprising:
at least one programmable memory circuit configured to receive and store parameters representing a first nonlinear function; and
a selector circuit configured to retrieve parameters from the at least one programmable memory circuit, the parameters representing a nonlinear function corresponding to an activation function to be applied with the processed value; and
a neural task manager circuit configured to send, to the post-processor circuit, first configuration data corresponding to a first task descriptor defining a configuration of a neural processor circuit to execute a current task, the configuration data including the at least one programmable memory circuit.
